(19) United States
(12) Patent Application Publication
(10) Pub. No.: US 2011/0199487 A1
(43) Pub. Date: Aug. 18, 2011

(54) METHOD FOR OPERATING REMOTELY CONTROLLED CAMERAS IN AN INDUSTRIAL PROCESS

(75) Inventors: Kristoffer Husøy, Oslo (NO); Charlotte Skourup, Drammen (NO); Tone-Grete Graven, Oslo (NO)

(73) Assignee: ABB RESEARCH LTD.

(21) Appl. No.: 12/594,031

(22) PCT Filed: Mar. 27, 2008
(86) PCT No.: PCT/EP08/53608

§ 371 Date: Feb. 16, 2010

(30) Foreign Application Priority Data
Mar. 30, 2007 (EP) 07106363.1

(51) Int. Cl. H04N 7/18

(52) U.S. Cl. 348/159; 348/E07.085

(57) ABSTRACT

A method to operate a camera to focus on a selected object or a process object of interest in an industrial installation, and automatically calculating which camera or cameras are in line of sight of the object of interest utilizing measurements on a 3D model of the installation and the cameras. A system is also described. The camera may be automatically operated to move, or pan or tilt or zoom the camera so as to point and focus on the process object of interest. A video stream or an image of the object of interest is then generated and displayed.

### TECHNICAL FIELD

This invention describes a system and a method for engineering and operation of a video monitoring system from within an industrial control system. In particular the invention is concerned with calculating which cameras have an unobstructed line of sight to specific locations within the process plant by means of an accurate 3D model of the plant including all onsite equipment and the location of each camera or video surveillance camera.

### TECHNICAL BACKGROUND

In the field of process control in industrial plants there is a continual requirement for information about process equipment and process objects. As well as process monitoring equipment, temperature sensors, pressure sensors and so on, video imaging may be used to provide a real-time image of an object or a process. Display screens showing CCTV images (closed circuit television) may be arranged in a control room monitoring one or more parts of an industrial plant. CCTV images may be displayed showing parts of a process line or process equipment. U.S. Pat. No. 5,095,365 assigned to Hitachi, describes an abnormality monitoring system in which monitoring frequency is changed according to the operating state of devices to be monitored. Abnormalities may be determined by automatically comparing template images to current pictures produced by a CCTV camera.

US 20060241793 entitled Human-machine interface for a control room, assigned to ABB, describes an industrial control system in which access to a CCTV system is integrated into an industrial control system. By means of selection using a human-machine interface of the control system disclosed in the application, images from the CCTV system of an equipment, object or location selected may be displayed.

In current control rooms with CCTV monitoring and moveable cameras, an operator manually maneuvers a CCTV camera by remote control and through the use of a joystick, or a joystick-like device. Another alternative is to store all pre-defined positions in the cameras or directly as code in the process graphics during the engineering phase. These methods of controlling each CCTV camera are relatively cumbersome and laborious, particularly when the process is re-engineered. In addition, it is difficult for an operator to operate a CCTV camera to change a view and get a new object into view quickly, which may have implications for safety issues in critical situations.

In order to achieve automatic camera control today, a great amount of manual engineering is required. Any type of link between camera selection and positioning and control object or control event needs to be programmed into the system in advance, per control object or per control event. In most cases this is done by storing a number of positions in the camera. The control system can then be programmed to send a command to a specific camera when some event is detected. For example when a gas alarm is detected in area A, send command to camera 99 to move to position B. This means that the cameras may only be used to monitor automatically certain critical equipment that has been already identified in advance. If an area needs to be monitored that has not been configured in the system in advance, the operator will have to select the appropriate camera and redirect it to overlook this area manually. These limitations in current systems also greatly reduces its flexibility, as the size and complexity of the plant often increase requiring a greater number of number of cameras installed, which require more extensive configuration.

### SUMMARY OF THE INVENTION

According to an aspect of the present invention an improvement is provided in the form of an improved method for engineering and operating a system comprising of one or more remotely-controlled and stationary and moveable cameras in an industrial installation, by means of using a 3D-model comprising the industrial installation and the cameras including information about movement ranges of the cameras, and by automatically determining which one or more cameras are or can be moved to be in line of sight of a selected object.

According to an embodiment of the present invention an improvement is provided in the form of an improved method for engineering and operating a system comprising of one or more remotely-controlled and stationary and moveable cameras in an industrial installation, by means of using a 3D-model comprising the industrial installation and the cameras to calculate which camera or cameras are in line of sight of the object, and by determining what camera movements and pan, tilt, zoom and focus settings are required in order for at least one of said one or more cameras to focus on the selected object.

According to another embodiment of the present invention an improvement is provided in the form of an improved method for engineering and operating a system comprising of one or more remotely-controlled and stationary and moveable cameras in an industrial installation, by means of using a 3D-model comprising the industrial installation and the cameras to calculate which camera or cameras are in line of sight of the object, and by ranking one or more cameras in line of sight of the selected object.

According to another embodiment of the present invention an improvement is provided in the form of an improved method for engineering and operating a system comprising of one or more remotely-controlled and stationary and moveable cameras in an industrial installation, by means of using a 3D-model comprising the industrial installation and the cameras 2 to calculate which camera or cameras are in line of sight of the object, and by moving, following an operator request, the camera automatically to point and focus on the selected object of interest.

According to another embodiment of the present invention an improvement is provided in the form of an improved method for engineering and operating a system comprising of one or more remotely-controlled and stationary and moveable cameras in an industrial installation, by means of using a 3D-model comprising the industrial installation and the cameras 2 to calculate which camera or cameras are in line of sight of the object, and by generating a request from a control system for moving the camera to point and focus on the selected object of interest which is any from the group of: alarm, event, process condition.

According to another embodiment of the present invention an improvement is provided in the form of an improved method for engineering and operating a system comprising of one or more remotely-controlled and stationary and moveable cameras in an industrial installation, by means of using a 3D-model comprising the industrial installation and the cameras 2 to calculate which camera or cameras are in line of sight of the object, and by the further step of recording the live video stream of the process object, or displaying it to an operator.

According to another embodiment of the present invention an improvement is provided in the form of an improved method for engineering and operating a system comprising of one or more remotely-controlled and stationary and moveable cameras in an industrial installation, by means of using a 3D-model comprising the industrial installation and the cameras 2 to calculate which camera or cameras are in line of sight of the object, and by the further step of displaying the live video stream or image of the process object, to an operator or other authorised user at a second location or at a location remote from the installation.

According to another embodiment of the present invention an improvement is provided in the form of an improved method for engineering and operating a system comprising of one or more remotely-controlled and stationary and moveable cameras in an industrial installation, by means of using a 3D-model comprising the industrial installation and the cameras 2 to calculate which camera or cameras are in line of sight of the object, and by the step of storing in a list information for each process object the one or more cameras determined to be in line of sight of the process object, together with the control information necessary to move each of the one or more cameras to point and focus on the object.

This invention describes a system and a method for automatic control of video cameras, industrial video cameras or CCTV systems within the process field. The control system automatically determines which of the video cameras are accessible and can be used to view a particular real-world object. Further the control system also automatically manoeuvers the selected camera, or cameras, to get an appropriate view of the object (eg by means of tilt, pan, zoom and focus commands).

The control system utilises a 3D model of the process in an industrial installation, including the positions of the video cameras in the installation, to decide which video camera has an unobstructed line of sight to a specific real-world object within the process plant. The 3D model comprises information about the real-world objects and equipment such as pumps, valves and meters in the process and, in addition, information about each of the video cameras such as their positions and how it can be moved, range of movement, zoom or focus capabilities, and so on.

The control system must know which object in the process to view, which cameras can view this object and how this camera much be positioned (tilt, pan, zoom and focus) so as to view the object. In case there are more cameras that can display an object, the most appropriate camera must be chosen. The ‘most appropriate’ can be, for example, the camera that has the best/closest view of the object, or it can be one or more of the cameras which are currently occupied by viewing another object.

This invention solves the problem using an accurate 3D model of the process. This 3D model includes all equipment and process objects, their positions, sizes and functionality. In addition the 3D model includes all video cameras including their positions and other characteristics, range of movement and so on. When the operator or the control system decides to view a particular real-life object within the process field, the control system automatically selects the video camera which is accessible and closest located or will result in the best view. The 3D model calculates the line of sight for each video camera, i.e. which of the video cameras that can actually view the particular real-life object. The control system automatically manoeuvers by eg tilt, pan and zoom movements the selected video camera or cameras to make an image and retrieve the best view of the object. The calculated line of sight is stored in the control system for later use.

An important part of this invention lies in the automatic configuration of a video camera system. When either the number of cameras or the number of process objects is large, the configuration of the system becomes quite complex and time consuming. By using a 3D model of the plant and all video cameras, the system can automatically determine if an object can be viewed from one or more of the cameras, and if yes: how to orient and zoom the cameras in order to view the process objects. This can be determined by using the 3D model, and the correct parameter settings for the camera can then be applied to the real-world cameras to view the real-world process object.

The invention proposes to control CCTV cameras automatically to view real-world objects within the process based on an integrated 3D model of the process which also holds information about the CCTV cameras and their potential working area. Whether a particular video camera can view an object is decided run-time based on information from the 3D model. The control system automatically determines the line of sight from a particular video camera to the object. The specific line of sight so determined to the object is then stored within the control system for later use. In the case when there have been modifications to the real-world process, the 3D model has to be updated accordingly. An indicator within the control system may be used to signal that the line of sight has to be re-calculated.

An important advantage of the invention is that it may be used to capture images of a process or process object efficiently, simply and quickly. An image of a process object may be carried out automatically, including camera selection, camera movement, image capture and then display, so that an operator who may be concerned about a critical situation can concentrate on control aspects instead of having to select the best situated camera and maneuver it to make an image of the process. This also reduces the time necessary to get an object into view, which is a safety issue in critical situations.

Another advantage is that the invention may be used to simply and quickly capture images by any authorised operator on duty in the plant, as detailed knowledge of physical plant layout and equipment position is not required. Only a selection of a process or process object of interest, for example as a result of an event or alarm. The most suitable camera is automatically selected and then moved and focussed on the object without any input from an operator being required. Instead of a separate system, console and bank of CCTV screens, real-time video streams from the plant may become an integrated part of the operator HMI.

Another advantage is that this solution is very robust and scalable. It can handle a relatively unlimited number of cameras and an almost infinite number of viewable objects. The inventive solution is easy to extend with new cameras and configure them; it is only camera related parameters that have to be to entered into the control system when automatic processing of line of sight to real-life objects is available.

It is necessary to update the 3D model to include modifications in the process configuration. Run-time computation of line of sight may be time-consuming for the first time and after each modification to a process object or location.

According to another aspect of the present invention an improvement is provided in the form of a 3-D model for operating one or more remotely-controlled stationary and moveable cameras, arranged with means to register input of a selection of an object of interest in an industrial installation, and means for determining from said 3-D model and a known position of one or more cameras in the model which camera or cameras are in line of sight of the process object, and means for remotely moving the camera to point and focus on the object of interest, and means for displaying an image or a video stream of the process object.

According to another embodiment of the present invention an improvement is provided in the form of an improved 3-D model for operating one or more remotely-controlled stationary and moveable cameras, for determining from said 3-D model and a known position of one or more cameras in the model which camera or cameras are in line of sight of the process object, wherein the 3D model is implemented by a computer and computer software or programs and wherein the 3D model may be implemented by a computer assisted design program or by a computer graphics program.

According to another aspect of the present invention an improvement is provided in the form of control system for operating one or more remotely-controlled moveable and stationary cameras, comprising means for remotely moving the camera to point and focus on an object of interest, arranged with input means to register input of a selection of a said object of interest in an industrial installation, and means for determining from a 3-D model and a known position of one or more cameras in the model which are in line of sight of the process object, and means for remotely moving the camera to point and focus on the object of interest, and means for displaying an image of the process object.

Another advantage is to have a unified interface, human-machine interface HMI, for CCTV through, for example, automation system-like faceplates or other forms of graphical display. A further advantage is the ability for an operator to control the movement of the camera from the process graphics. An example of how this could be used is this: when an operator right-clicks an object in a process graphic he/she can choose to “view object in camera”, which automatically presents a view of the object on a monitor. This involves the automatic system selecting which camera can be used to view the selected object (or which has the best view) and then manoeuvering the camera (pan/tilt/zoom) so the selected object is shown in view. Another advantage of this integration is that process events can be used to automatically initiate commands to the CCTV system. E.g. the control system may be configured to begin manoeuvring a camera in line of sight when a pre-determined event or an alarm occurs for this process, or process object.

In a preferred embodiment of the methods of the invention one or more methods may be carried out by a computing device comprising one or more microprocessor units or computers. The control unit(s) comprises memory means for storing one or more computer programs for carrying out the improved methods. Preferably such computer program contains instructions for the processor to perform the method as mentioned above and described in more detail below.

### BRIEF DESCRIPTION OF THE DRAWINGS

Embodiments of the invention will now be described, by way of example only, with particular reference to the accompanying drawings in which:

FIGS. 1a-d are schematic diagrams showing a layout and the relative position in space of cameras and objects for calculating whether an object is in line of sight of one or more cameras according to an embodiment of the invention,

FIG. 2 is a flowchart for a preferred method of calculating line of sight to an object and camera position and storing the information about camera number and position, according to an embodiment of the invention,

FIG. 3 is a flowchart an object to be viewed by means of for calculating line of sight between the object and a camera position by means of a 3-D model and storing the information about camera number and position, according to another embodiment of the invention.

### DETAILED DESCRIPTION OF THE EMBODIMENTS

This invention describes a method that has information available about which camera should be used to view an object and further, information to be able to calculate whether a given camera has a clear line of sight to that specific object. The method also determines the settings such as pan, tilt, zoom and focus for the camera. In case there are more cameras that can view an object, the most appropriate camera is selected.

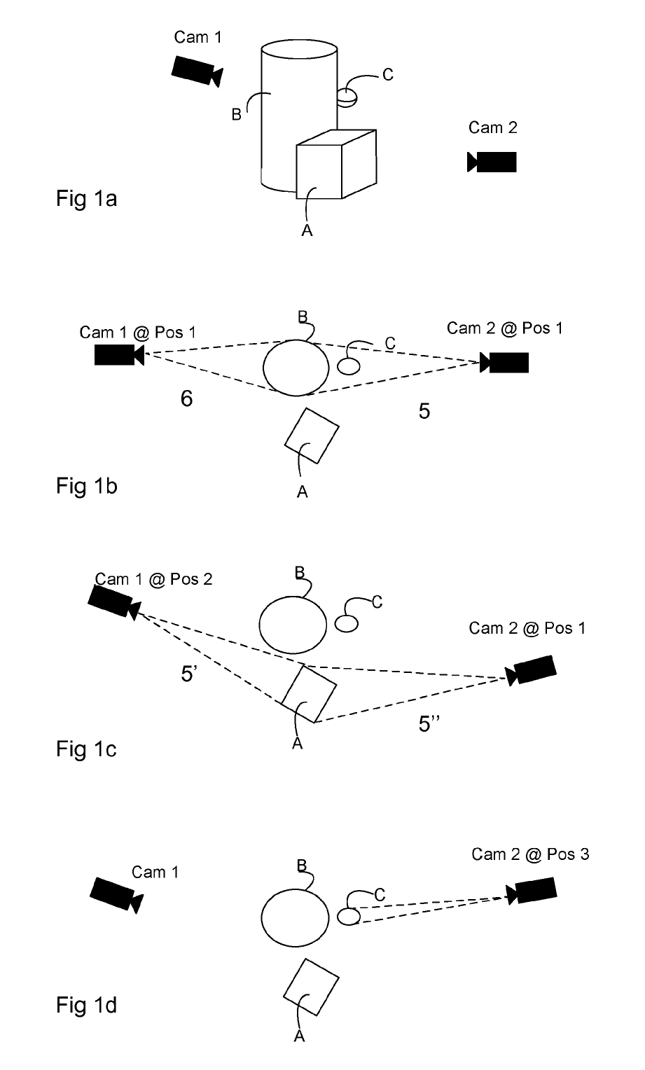

FIG. 1 a shows a 3-D view of a group of objects A, B, or C representing equipment such as a tank or a building in an industrial installation, and two cameras 1, 2 positioned nearby. Object C represents an object of interest, which may be an item of equipment, a valve, a transformer and so on. FIG. 1b shows a first view from above looking down on the objects. It is shown there that camera 1 in position 1 does not 6 have line of sight to object C, and that camera 2 at position 1 has line of sight 5 to object C. This may be calculated by a computer implemented method using a program for manipulating 3-D models. A computer model such as a model of the three schematic objects A, B, C and the two cameras 1, 2 and their respective position may be used to calculate the position of a line of sight between a camera at a defined position in space and an object at a defined position in space. Further, the available extent of movement for each camera is registered first to ensure that a camera at a position may be in line of sight, and secondly to calculate which movements, eg, pan, tilt, zoom are required for the selected camera to move to a position where the object of interest is in focus, or in focus and centered in an image. A 3-D computer graphics package or a computer program for manipulating CAD drawings (Computer Assisted Design) may be used to calculate line of sight within the computer model of the industrial installation or process plant of interest.

FIG. 1c shows a second view from above looking down on the objects. It shows a position of camera 1, position 2; and of camera 2 position 1 in which lines of sight 5′ and 5″ are available to object A. Figure d shows the case when camera 1 is not in line of sight of object C. Camera 2 at position 1 is in line of sight of C.

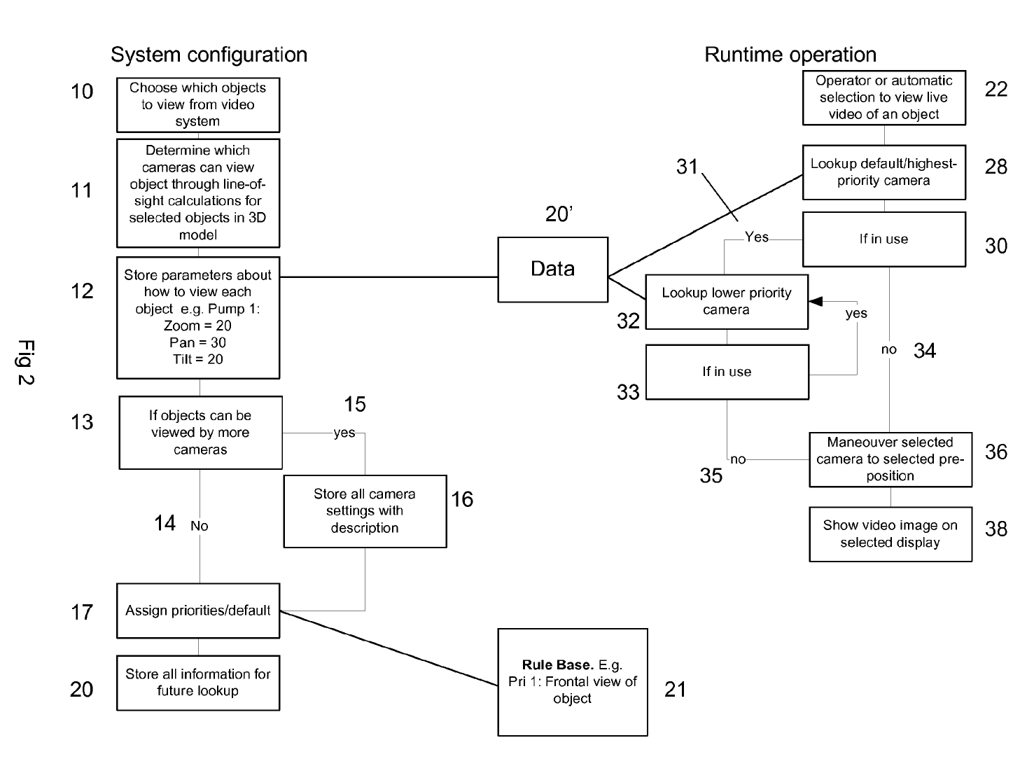

FIG. 2 is a flowchart for to preferred method for remotely operating a camera automatically to make an image of an object in an industrial installation. The flowchart shows a series of steps comprising the actions during a configuration phase of:

10. Operator (or system, below) chooses which object to view from video system

11. Determine which cameras can view the object though line of sight calculations for selected objects represented in the 3D model

12. Store parameters for camera settings about how to view each object, eg Pump 1, Zoom=20, Pan=30, Tilt=10

13. Determine if the elected object can be viewed by more that one camera, if

15. Yes then

16. Store all settings for all cameras in for this object with a description,

17. Assign priorities for the different camera views and/or a default view for this object, may be a rule base such as Priority 1, Frontal view of object,

14. if No then decide priorities, default view,

20. Store all information per object for future lookup (see step 21)

and a series of steps comprising the actions during a runtime operation of:

22. Operator or automatic selection to view live video of an object

28. Lookup a default or highest priority camera for that object, by checking the Data 21 stored for cameras and stored camera parameters for viewing each object;

30. If the first camera is found to be in use:
31. Yes
32. Look up a lower priority camera
33. If the second camera is in use then 32. Look up a lower priority camera
35. if No then
34. If NO, then

36. Maneouver the selected camera to the predetermined position for the selected object

38. Show video image on selected display Thus the line of sight calculations are advantageously done beforehand during an engineering phase. Line of sight calculations can be carried out during runtime but this may take an inconvenient amount of time.

Thus a list of cameras and camera positions is made up and stored 20, 21 during a configuration phase. Based on the line of sight calculated by using the 3-D computer model, and based on the known parameters for each camera regarding their movement range in terms or pan, tilt or zoom, the system automatically stores the parameters necessary to steer the selected camera to point at the stored position of the object and focus. A priority and/or default list for which camera of a plurality of cameras that can view the object shall be selected to view the object may be constructed in different ways to suit one or more rule based schemes. It may be based on any combination of best image, largest image, type of current alarm, default selection and so on.

Any of the cameras in the plant may also be stationary cameras, in a fixed position, only capable of zoom and focus. The majority of cameras may be arranged as moveable in terms of pan, tilt and zoom, and the information recording the extent or limits of available movement for each camera is stored accessible from the model for calculating line of sight. Thus in the line of sight calculation the available range of movement of a camera may also be calculated or determined to establish whether the camera can be moved in to line of sight, and secondly the which movements the camera will have to make so as to point at and focus on the object. In addition, one or more cameras may be mounted on a moveable device, such as a crane or a robot or on a rail. Such a camera may then have movement forward or back in a linear direction as well as tilt and pan.

Normally an operator will choose an object 10 he/she wishes to view. However the invention may also be arranged in a further embodiment to automatically select and steer a camera to view a certain object on the occurrence of a pre-determined event or alarm. When the automatic camera control system is linked to the process control system, information about the alarm can advantageously be superimposed over the view of the object associated with the event or alarm. In this way the operator can see at once what kind of alarm it is as the camera starts focus on and/or move to the object.

In an advantageous development the 3-D model may be used to calculate where a camera shall be positioned. When there is, for example, a safety requirement that redundancy is required, such as that two cameras are positioned within line of sight of a process equipment or other type of process object, the 3-D model may be used to calculate, through analysis of line of sight modeling and calculation, the possible positions from which a first and/or second camera would have line of sight to the object. The invention may thus be used to determine best position for an additional camera. The invention may also be used to calculate an optimal positioning or an optimum position to fulfill requirements for video coverage such as for security purposes or to comply with hazardous materials.

(text mention of moving object)

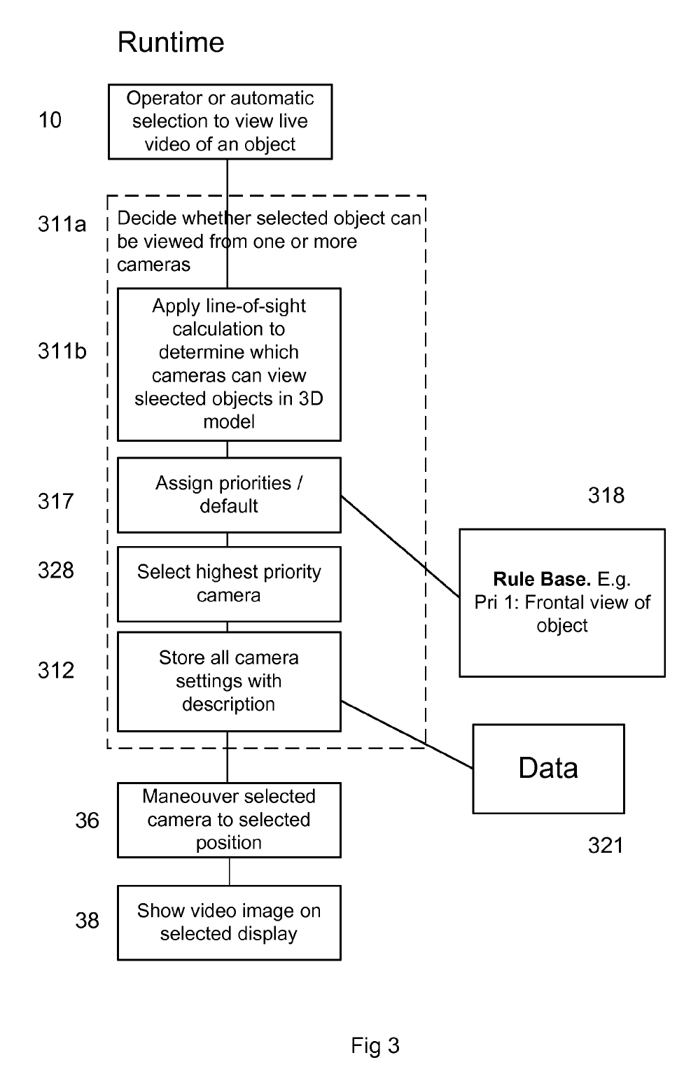

In an alternative embodiment the invention may be applied using a different sequence of method steps. For example FIG. 3 shows a flowchart in which the steps are numbered with the same reference numbers when the operation is the same as FIG. 2, and where the steps are in a different sequence, the similar steps are shown numbered with numbers in the 300 range:

10. Operator or system selects to view a live video of an object 211a. Decide whether the selected object can be viewed from one or cameras
211b. Apply line of sight calculation to determine which cameras can view selected objects represented in the 3D model
217. Assign priorities for the different camera views and/or a default view for this object,
   218. may be a rule base such as Priority 1, Frontal view of object, such as checking—is the camera in use by other operator,
328. Select highest priority camera for that object
312. Store parameters for camera settings about how to view each object, eg Pump 1, Zoom=20, Pan=30, Tilt=10
   321. Store all parameters for camera settings with description

36. Maneouver the selected camera to the predetermined position for the selected object

38. Show video image on selected display

The above description in relation to FIG. 3 is applicable to a sequence of actions initiated by an operator, or automatically by a system when pre-determined conditions are fulfilled. It may be understood that an operator at a control panel for controlling the CCTV cameras, or at a control interface which is connected to or integrated with an interface of a control system, selects an object that he/she wants to view and that the system remotely controlling the CCTV cameras then automatically provides an image or a live video stream of that object. If the object has not been viewed or configured previously, then line of sight calculations are carried out in real time and the image or video is displayed subsequently. If the object has not been viewed or configured previously, the real-time line of sight calculations can be stored for future reference.

Methods of the invention may be supervised, controlled or carried out by one or more computer programs. One or more microprocessors (or processors or computers) comprise a central processing unit CPU connected to or comprised in one or more of the above computers or computer systems, which processors or computers perform the steps of the methods according to one or more aspects of the invention, as described for example in reference to FIG. 2 and FIG. 3. It is to be understood that the computer programs for carrying out methods according to the invention may also be run on one or more general purpose industrial microprocessors or PLCs or computers instead of one or more specially adapted computers or processors.

The computer program comprises computer program code elements or software code portions that make the computer or processor perform the methods using equations, algorithms, data, stored values, calculations, synchronisations and the like for the methods previously described. A part of the program may be stored in a processor as above, but also in a ROM, RAM, PROM, EPROM or EEPROM chip or similar memory means. The or some of the programs in part or in whole may also be stored locally (or centrally) on, or in, other suitable computer readable medium such as a magnetic disk, CD-ROM or DVD disk, hard disk, magneto-optical memory storage means, in volatile memory, in flash memory, as firmware, or stored on a data server. Other known and suitable media, including removable memory media such as memory stick, a USB memory stick and other removable flash memories, hard drives etc. may also be used. The program may also in part be supplied or updated from a data network, including a public network such as the Internet.

It should be noted that while the above describes exemplifying embodiments of the invention, there are several variations and modifications which may be made to the disclosed solution without departing from the scope of the present invention as defined in the appended claims.

1. A method for engineering and operating a system comprising of one or more remotely-controlled and stationary and moveable cameras in an industrial installation, characterised by,
using a 3D-model comprising the industrial installation and the cameras including information about movement ranges of the cameras,
automatically determining which one or more cameras (1, 2) are or can be moved to be in line of sight of a selected object.

2. A method according to claim 1, comprising the further step of determining what camera movements and pan, tilt, zoom and focus settings are required in order for at least one of said one or more cameras to focus on the selected object.

3. A method according to claim 2, comprising the further step of ranking one or more cameras in line of sight of the selected object.

4. A method according to claim 2 or 3, comprising the further step of an operator request, moving the camera to point and focus on the selected object of interest.

5. A method according to claim 3, comprising the further step of generating a request from a control system for moving the camera to point and focus on the selected object of interest which is any from the group of: alarm, event, process condition.

6. A method according to claim 4 or 5, comprising the further step of recording the live video stream of the process object, or displaying it to an operator.

7. A method according to claim 6, comprising the further step of displaying the live video stream or image of the process object, to an operator or other authorised user at a second location or at a location remote from the installation.

8. A method according to claim 2 or 3, comprising the further step of storing in a list information for each process object the one or more cameras determined to be in line of sight of the process object, together with the control information necessary to move each of the one or more cameras to point and focus on the object.

9. A method according to any previous claim, comprising the further step of calculating what operations such as pan, zoom or tilt movements are necessary for each of the one or more cameras in line of sight to focus on the object.

10. A method according to claim 9, comprising the further step of calculating what movements of a crane or other moveable device with a camera arranged thereon, or along on rail, are necessary for each of the one or more cameras in line of sight to focus on the object.

11. A method according to any previous claim, comprising the further step of calculating line of sight using stored information on the available field of view and range of movement per camera.

12. A method according to any previous claim, comprising the further step of generating control signals to operate one or more cameras to focus on said process object and display a video stream or make an image of it.

13. A method according to any previous claim, wherein the selected object (C) of interest in an industrial installation is a process object, an equipment of process section in the industrial installation or any other object presently located in or moving through the installation, and by automatically determining one or more cameras (1, 2) which are in line of sight of the object, and moving the camera to point and focus on the object of interest, and displaying an image or a video stream of the object.

14. A method according to any previous claim, comprising the further step of monitoring a process object in an industrial plant with one or more processes by means of automatically moving a camera (1, 2) to focus on the selected process object (C) for control purposes.

15. A method according to claim 1 or 13, comprising the further step of registering one or more images or live video streams made of said process object and providing a display to a control system said process object is controlled by.

16. A method according claim 1 or 12, comprising the further step saving one or more images made of said process object in a database together with data associated with said process object and/or an event or alarm or process condition.

17. A method according to any previous claim, comprising the further step of calculating in real time which of the one or more cameras are in line of sight to an object of interest.

18. A method according to any previous claim, comprising the further step of calculating one or more lines of sight to an object of interest and calculating where a camera should be positioned in order to make an image or live video of the object of interest.

19. A computer program comprising software code elements which when read into a computer or processor will cause the computer or processor to carry out a method to operate one or more remotely-controlled moveable and stationary cameras to retrieve? according to the steps of any of claims 1-159.

20. A computer program embodied on a computer readable medium which when read into a computer or processor will cause the computer or processor to carry out one or more instructions for a method to operate a one or more remotely-controlled moveable and stationary cameras according to the steps of any of claims 1-18.

21. A 3-D model for operating one or more remotely-controlled stationary and moveable cameras, characterised by means to register input of a selection of an object (C) of interest in an industrial installation, and means for determining from said 3-D model and a known position of one or more cameras (1, 2) which are in line of sight of the process object, and means for remotely moving the camera to point and focus on the object of interest, and
means for displaying an image or a video stream of the process object.

22. A 3-D model according to claim 21, wherein the 3D model is implemented by a computer and computer software or programs.

23. A 3-D model according to claim 21, wherein the 3D model is implemented by a computer assisted design program or by a computer graphics program.

24. A control system for operating one or more remotely-controlled moveable and stationary cameras, comprising means for remotely moving the camera to point and focus on an object of interest, characterised by means to register input of a selection of a said object (C) of interest in an industrial installation, and means for determining from a 3-D model and a known position of one or more cameras (1, 2) which are in line of sight of the process object, and means for remotely moving the camera to point and focus on the object of interest, and means for displaying an image of the process object.

25. A control system according to claim 24, further comprising means to operate and move a crane or other moveable device arranged with a camera mounted on the moveable device.

26. A control system according to claim 24, further comprising a memory storage device including one or more computer programs comprising software code elements which when read into a computer or processor will cause the computer or processor to carry out a method to operate one or more remotely-controlled and moveable cameras to automatically make an image of a selected object (C) of interest according to the steps of any of claims 1-18.

27. A control system according to claim 24, further comprising an interface for selecting an object of interest presently in an industrial installation to automatically be displayed as in live video format and/or an image to be made of it.

28. Use of a computer-implemented 3-D model for operating one or more remotely-controlled moveable and stationary cameras.

29. Use of a control system for operating a one or more remotely-controlled moveable and stationary cameras for monitoring and control of a process object in an industrial plant with one or more processes, according to any of claims 18-27.

30. A method for automatically determining which cameras are presently in, or may be moved into, line of sight of a selected object of many by means of calculating a line of sight from a 3D model comprising the cameras and the many objects.

31. A high speed method for operating a one or more remotely-controlled stationary and moveable cameras, characterised by selecting a process object (C) of interest in an industrial installation, and automatically determining one or more cameras (1, 2) which are in line of sight of the process object, retrieving the pre-calculated movement necessary to move, or pan or tilt or zoom the camera so as to point and focus on the process object of interest, operating the camera according to the pre-calculated movements necessary to focus on the selected object and displaying a video stream or an image of the process object.
